(19) United States
(12) Patent Application Publication
(10) Pub. No.: US 2005/0030990 A1
(43) Pub. Date: Feb. 10, 2005

(54) Stability factors for tuneable multi-section semiconductor lasers

(76) Inventor: Neal O'Gorman, Dublin (IE)

Correspondence Address: SEYFARTH SHAW, 55 EAST MONROE STREET, SUITE 4200, CHICAGO, IL, 60603-5803, US

(21) Appl. No.: 10/493,879

(22) PCT Filed: Mar. 18, 2002
(86) PCT No.: PCT/IB02/00787

(30) Foreign Application Priority Data
Oct. 30, 2001 (IE) S 010954

(51) Int. Cl. H01S 3/00; H01S 3/10

(52) U.S. Cl. 372/38.07; 372/20; 372/38.01

(57) ABSTRACT

A method is described for qualifying a multisection semiconductor laser using measurements of excursions from stable operating conditions to neighbouring mode boundaries at which the laser undergoes mode-hopping. These excursions are measured when the laser is characterised to provide a measure of the stability and hence the quality of the laser, and to facilitate statisctical analysis of the quality of a batch of lasers from a given wafer. The values of the excursions may be re-measured during the life of the laser using a curtailed version of the characterising procedure rapidly to monitor aging or other deterioration of the laser.

This invention relates to stability factors for tuneable multi-section semiconductor lasers.

Tuneable semiconductor laser are used in, for example, telecommunications optical networks to transmit data on specified wavelength channels in a wavelength division multiplexed system. The efficient generation of a look-up table (LUT) necessary to control the tuning of a multi-section laser for such an application is known from, for example, WO01/28052. The look-up table stores values of parameters for controlling currents supplied to respective sections of the multi-section laser for which values the laser will operate stably remote from mode boundaries to emit radiation at a required frequency. There is a requirement for measurement of a quality control parameter of such lasers. Moreover, as the laser ages, or otherwise is degraded, the position of the mode boundaries may change with respect to the controlling currents, so that the laser becomes unstable by becoming subject to mode jumping and hence frequency hopping. Known methods of monitoring lasers after installation to ensure that they continue to operate stably involve long periods of downtime.

It is an object of the present invention at least partially to mitigate the foregoing disadvantages.

According to the present invention there is provided a method of characterising a tuneable multi-section semiconductor laser comprising the steps of a) applying currents in step-wise increments to sections of the laser respectively; b) measuring power output by the laser to determine values of the applied currents corresponding to respective stable operating conditions for which the laser emits radiation at wavelengths remote from mode boundaries of the laser; c) determining the respective wavelength of the emitted radiation; d) measuring variations in the applied currents required to cross a mode boundary such that the laser emits at a wavelength different from that under the respective stable operating condition; and e) storing in a look-up table respective values of applied currents for which the laser emits radiation at wavelengths remote from mode boundaries, the corresponding wavelengths of the radiation and the variations in applied currents required to cross adjacent mode boundaries.

Conveniently, step a) comprises applying currents in step-wise increments using a programmed waveform.

Conveniently, the programmed waveform has a frequency of substantially 100 kHz.

Preferably, the programmed waveform has a frequency of substantially 1 MHz.

Conveniently, step d) of measuring the variations comprises deriving the variations by determining distances in an applied current plane of a point corresponding to the stable operating condition from adjacent longitudinal and super-mode boundaries.

Advantageously, the stored variations are normalised.

Conveniently, the multi-section semiconductor laser has front, gain, phase and back sections and step a) includes the steps of a1) applying constant currents to the gain and phase sections such that the laser emits laser radiation; a2) applying back and front currents in step-wise increments to the back and front sections respectively; and step e) includes storing in a look-up table the values of front and back current for which the laser emits radiation at wavelengths remote from mode boundaries.

Advantageously, step c) includes step c1) providing an optical filter for transmitting a proportion of power of an incident light beam emitted by the laser, the proportion being dependant on the wavelength of the incident light beam; and step c2) measuring the proportion of power transmitted by the filter to determine the wavelength of the emitted radiation.

Conveniently, step a) comprises holding the front current at a first front constant and varying the back current, holding the front current at a second front constant and varying the back current, holding the back current at a first back constant and varying the front current, holding the back current at a second back constant and varying the front current, and increasing the front current from a third front constant to a fourth front constant while decreasing the back current from a third back constant to a fourth back constant in order to determine stable middle lines within each super-mode and wherein, having determined the stable middle lines, subsequent steps of varying the back current and/or the front current respectively comprise varying the respective current through a window of a plurality of incremental values along the stable middle lines and determining for which of the plurality of incremental values the power output is a minimum, and repeatedly incrementing each of the plurality of incremental values and re-determining the current value corresponding to the minimum output power within the window to determine a current value corresponding to a local minimum in the power output.

Advantageously, step b) comprises determining midpoints between the current values corresponding to local minima in the power output to obtain stable middle points of operation of the laser and step e) includes storing data representative of such stable middle points together with the corresponding wavelength of emitted laser light in the look-up table and wherein operational conditions for operating the frequencies between the stable middle point frequencies are determined by determining and storing in the look-up table the required values of phase current injected into the phase section of the laser and wherein the required values of phase current are determined by holding the back and front currents constant successively at a first stable point and incrementing the phase current until a frequency of laser emission corresponding to a next stable point is reached and calculating what increments of phase current are required to step from the first stable point to the second stable point in desired frequency increments.

Conveniently, the method comprises the further step of f) measuring the variations in the applied currents at predetermined intervals of time to determine new values of the variations; and g) comparing the new values with previously determined values of the variations to determine whether any change in the values is sufficient to require re-characterisation of the laser.

Advantageously, step g) comprises comparing the new values with values stored in the look-up table when the laser was last characterised.

Conveniently, the step of determining whether any change in the values is sufficient to require re-characterisation of the laser comprises determining whether the variations are greater than a predetermined value or represent more than a predetermined percentage change.

A specific embodiment of the invention will now be described by way of example with reference to the accompanying drawings, in which:

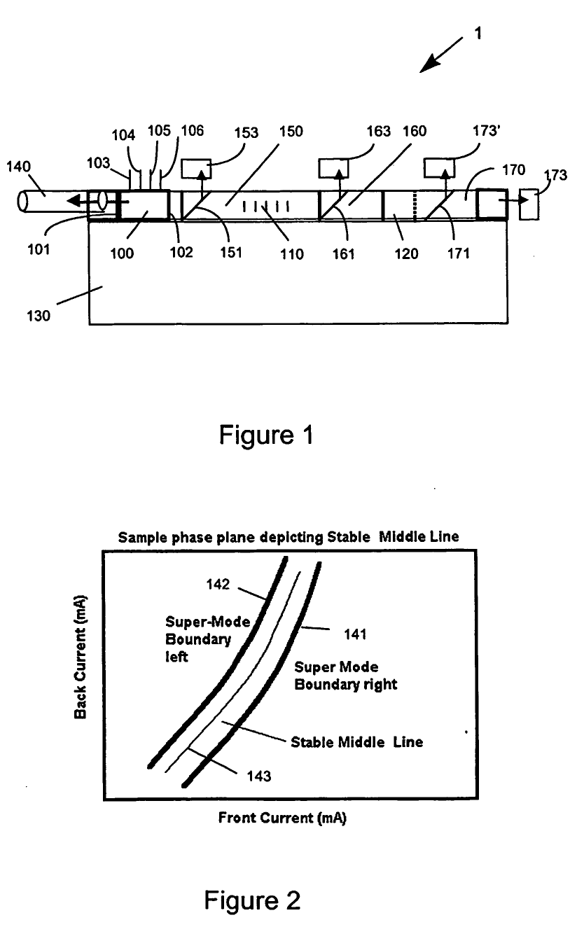

FIG. 1 is a schematic side view of an apparatus for characterising a multi-section semiconductor laser suitable for use in the present invention;

FIG. 2 shows a plot, useful in understanding the method of the invention, of current injected in a front section and current injected in a back section of a multi-section laser showing a stable middle line between two super-mode boundaries;

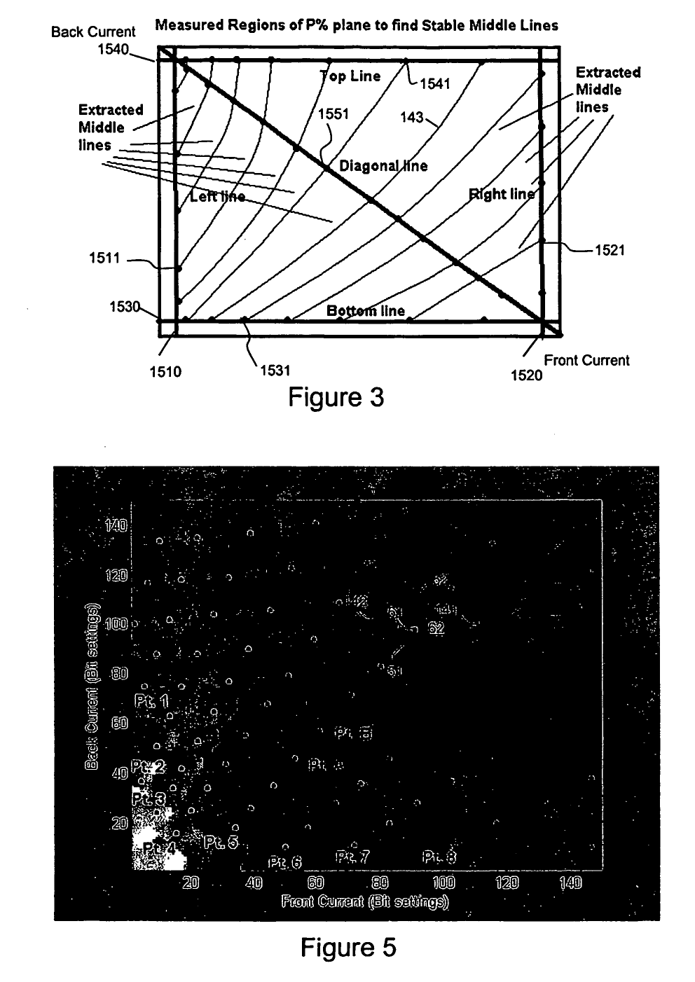

FIG. 3 shows a graph, useful in understanding the method of the invention, of current injected in a front section of the laser of FIG. 1 as abscissa versus current injected in a back section of the laser of FIG. 1 as ordinates, to determine the positions of stable middle lines such as that shown in FIG. 2;

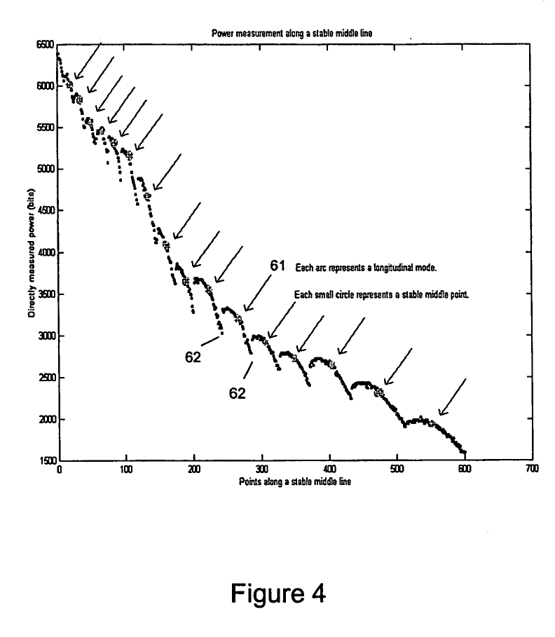

FIG. 4 shows a graph of power output of the laser of FIG. 1 along a stable middle line between mode boundaries such at that shown in FIG. 2, with distance along the middle line as abscissa and power emitted as ordinates;

FIG. 5 shows a plot derived from FIG. 4, of stable operating positions between super-mode and longitudinal mode boundaries for the laser of FIG. 1;

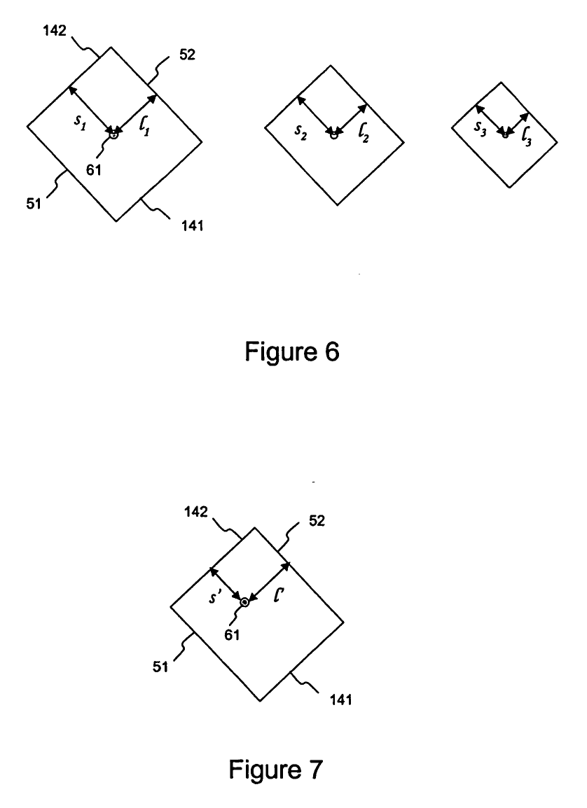

FIG. 6 shows a detail of FIG. 5, showing diagrammatically the location of stable operating points between super-mode and longitudinal mode boundaries;

FIG. 7 shows an operating point of FIG. 6 after ageing of the laser; and

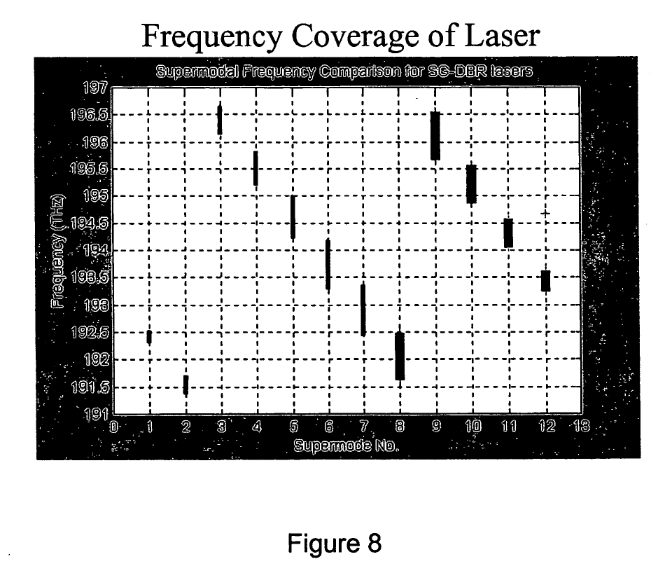

FIG. 8 shows a graph of frequencies as ordinates vs supermode number as abscissa used in a quality control embodiment of the invention.

In the figures, like reference numerals refer to like parts.

Referring to FIG. 1, there is shown a schematic side view of an optoelectronic device 1 as disclosed in WO01/28052 for characterising a multi-section laser 100. As shown in FIG. 1, the multi-section laser 100, a long period grating, or feature extraction filter, 110, and a Fabry Perot etalon 120 are serially located on a silicon substrate 130. Alternatively, a silicate or silicate-on-silicon substrate may be used. A long period grating is a grating in which corrugations or “lines” are sufficiently widely spaced that a transmission or reflection spectrum generated by the grating is sufficiently broad to give a monotonic variation with wavelength over, for example, the C-Band or L-Band, or both, for optical fibre networks. The grating may alternatively be incorporated in an optical fibre or a dielectric filter producing a similar monotonic transmission spectrum. The laser may be, for example, a known four-section InGaAsP sampled grating distributed Bragg reflector (SG-DBR) laser or a gain coupled sampled grating reflector (GCSR) laser. In the latter case one grating section is a middle section, the coupler. Alternatively, a superstructure SG-DBR (SSG-DBR) laser may be used. The invention is also applicable to, for example, a five-section laser, the fifth section being a semiconductor optical amplifier to provide a higher power output. The invention is also applicable to, for example, a three-section laser rather than a four-section or five-section laser. An electro-absorption modulator (EAM) may be monolithically integrated, or hybridised with the laser to provide data modulation of the laser output.

Rather than being connected to the inline, hybridised Fabry Perot etalon, the output of the long period grating, or feature extraction filter, may be connected to an external frequency locker, not shown.

Input leads 103,104,105,106 are provided for injecting currents into the sections of the laser respectively. A first output facet 101 of the laser is optically connected to an output optical fibre 140. The optical fibre may be located in a V-groove in the silicon substrate for ease of positioning in relation to the laser.

A second facet 102 of the laser, opposed to the first facet, (or beam split light from the first facet 101 in the case of a GCSR) is optically connected by a first integrated optical waveguide 150 to the long period grating, or feature extraction filter, 110. The waveguide may be, for example, silicate glass on silicate substrate. Alternatively, the waveguide layer may be another glass, or silicon or another semiconductor. The waveguide layer may be deposited on silicate, glass, silicon or another semiconductor substrate. Within the integrated optical waveguide there is located a first beam splitter 151 for diverting a proportion of the light emitted from the second facet 102 of the laser towards a first photodiode 153. The photodiode may be a known InGaAs photodiode.

In an alternative application of the invention, the laser, waveguide and photodiodes may form a monolithic device in a semiconductor alloy, rather than being combined in a hybrid optical device. By a hybrid optical device it is to be understood a hybrid of active and passive devices or a hybrid of devices in different materials e.g. glass and semiconductor.

The known long period grating, or feature extraction filter, has a transmission characteristic in which the percentage of power transmitted is substantially linearly inversely proportional to the wavelength of incident light. For example, a transmission percentage varying from 10% to 90% in the range 1520 nm to 1560 nm in a substantially linear manner is useful for C-band operation. Variations of 5% to 95% have been achieved. This range is crucial to precision wavelength identification.

The output of the long period grating, or feature extraction filter, 110 may be optically connected by a second integrated waveguide 160 to the input of the Fabry Perot etalon 120 or to an external frequency locker. A second beam splitter 161 in the second integrated waveguide 160 deflects a proportion of light emergent from the long period grating, or feature extraction filter, 110 towards a second photodiode 163.

Instead of the long period grating, or feature extraction filter, filters of other types may be used. For example, a photonic band-gap crystal, with a slowly changing spectral response, may be utilized. Alternatively, a fibre optic coupler designed to separate two wavelength bands at 1480 nanometres and above is very suitable for C-band use, as such a coupler has an almost linear transmission power characteristic, decreasing with increasing wavelength. Such a coupler can be calibrated with a wave-meter and then used repeatedly without further accessing the wave-meter. In this embodiment, the long period grating, or feature extraction filter, is therefore omitted and replaced with a simple waveguide. Light from the waveguide passes through the fibre filter before reaching the second photodiode. Other possible filters are an optical fibre with an embedded diffraction grating or a coloured glass filter, for example, of a type used with NdYAG lasers.

Although, as described, the characterising functions are carried out from light emitted from a “rear” face of the laser, all these characterising functions can be carried out from the “front” power output face. This is particularly so in the case of a gain coupled sampled grating reflector (GCSR) laser, for example.

In order to characterise the laser it is necessary to find stable positions, remote from mode boundaries, where the laser will operate at a stable frequency without mode-hopping. Such stable points may be found on stable middle lines 143 halfway between super-mode boundaries 141,142, as shown in FIG. 2.

As disclosed in WO01/28052 and shown in FIG. 3, the position of these stable lines can be obtained by sampling. Measurements are made in five stages along five or more lines of measurement as follows. The front current is held at a first constant value 1510 and the back current varied to determine stable points 1511 corresponding to intersections of stable middle lines with this first line of measurement. The front current is held constant at a second value 1520 and the back current varied along a second line of measurement to determine stable points 1521 representing points of intersections of the stable middle line with the second line of measurement. The back current is held constant at a third constant value 1530 and the front current is varied along a third line of measurement to determine stable points 1531 representing points of intersection of the stable middle lines with the third line of measurement. The back current is held constant at a fourth value 1540 and the front current is varied along a fourth line of measurement to determine stable points 1541 represented by an intersection of the stable middle line with the fourth line of measurement. The front current is increased from the first constant value 1510 to the second constant value 1520 while the back current is decreased from the fourth constant value 1540 to the third constant value 1530 along a fifth line of measurement to find points of intersection 1551 of the stable middle lines with the fifth line of measurement. Conveniently, the currents are varied by a fast programmed waveform with a frequency in the region of 100 kHz. With faster electronics it is anticipated that Megahertz frequencies may be used. Stable middle lines 143 can then be plotted by joining corresponding points of intersection on the respective lines of measurement as shown in FIG. 3. To refine plotting of the stable middle lines, additional diagonal lines of measurement, parallel to the diagonal line of measurement shown in FIG. 3, may be used. In an embodiment of the invention up to 100 diagonal lines of measurement may be used with pre-programmed waveforms rapidly to produce a mode map (see FIG. 5) for visual inspection. In the case of GCSR lasers, in the fifth step, the front and back currents respectively may be varied between different constants, to accommodate a different orientation of the super-modes in GCSR lasers.

In this manner it is possible to plot a number of stable middle lines between super mode boundaries such as that shown in FIG. 2. The stable operational points are then sought on these stable middle lines 143 midway between longitudinal mode boundaries 51,52 which transversely cross the stable middle lines 143 and the super-mode boundaries 141,142.

Moving along such a middle line and measuring the direct power for each point results in a plot such as that shown in FIG. 4. The local minima 62 in the power output correspond with the longitudinal mode boundaries 51,52. The requirement then is to find the stable points 61 which are taken to be midway between two local minima 62 in the power output. To determine the local minima 62 a moving window may be used which has a fixed number of measurement points, for example, initially 10 points. The point, within the 10 points of the window, having a minimum power value is recorded and then the window moved by one point to determine the new point having a minimum power. A local minimum 62 is that point which returns a minimum value for each of 10 successive movements of the window. However, as can be seen from FIG. 4, further along the middle line a wider window is required to encompass the wider arcs, up to 150 measurement points, for example.

Having established the local minima, the positions of the stable middle points 61 can be located as shown in FIG. 4, being midway between local minima. As the position of the stable middle points are established they may be stored in a look-up table.

In this manner stable points 61 located between super-mode boundaries 141,142 and between longitudinal mode boundaries 51,52 may be identified as shown in FIG. 5.

Operational conditions for operating at frequencies between the stable middle point frequencies are determined and stored in the look-up table. The required values of phase current injected into a phase section of the laser are determined by holding the back and front currents constant successively at a first stable point and incrementing the phase current until a frequency of laser emission corresponding to a next stable point is reached and calculating what increments of phase current are required to step from the first stable point to the second stable point in desired frequency increments.

Referring to FIG. 6, the present invention provides a method to produce stability factors, shown by double arrow-headed lines s,1, in relation to each of these stable points 61 respectively that indicate whether mode-hopping is likely or becoming more likely with ageing or other degradation. These stability factors s,1 measure the distance of the stable operating points from the mode boundaries 52,142 that characterize the laser behaviour when the tuning currents are incremented. The nearer the operating point 61 is to a mode boundary 52,142 the more likely that a mode hop is imminent thereby de-stabilizing the communication network.

The laser has two coarse-tuning electric currents, I_{F} and I_{B} (front and back grating sections for SGDBR lasers) or I_{G} and I_{C} (grating and coupler sections for GCSR lasers) and the laser power and wavelength are first characterized as a function of these two inputs as described above. This produces planes of data that are divided by mode boundaries 51,52,141,142 that must be avoided to prevent mode-hopping by the laser. The mode regions 62 between mode boundaries generated by the method disclosed in WO01/28052, and outlined above, have a distribution of sizes depicted schematically in FIG. 6 with stable operating points 61 of the laser are at the centre of each region, having respective stability factors s₁,l₁; s₂,l₂, and s₃,l₃.

Stable middle points 61 inside the mode regions 62 have a range of implied “stability” as indicated by values s and l, that is the distances of the stable points from the neighbouring super-mode boundaries 142 and longitudinal mode boundaries 52 respectively, or by their values when normalised to an average of the highest 10% of values giving S and L, each between 1.0 and 0.3 typically. Thus, a channel with L,S=0.5,0.4 for example is less inherently “stable” than one with L,S=0.9,0.8. Alternatively, some other suitable reference values of 1 and s representing a reticle of a reference size of mode region 62 may be used to normalise the values.

An extended LUT includes L,S for use as a quality control parameter for selection of excellent lasers and also to facilitate statistical analysis of a batch as well as for monitoring ageing of the lasers.

The monitoring method comprises a curtailed version of the look-up table generation procedure described above to check s and l values to ascertain whether ageing is causing the original “stability” to deteriorate.

The initial values for the stable points are determined during the processing stage illustrated in FIG. 4. That is, having determined a position mid-way between two local minima, the distance 1 from the mid-way position, representing a stable point, and a local minima, representing a longitudinal mode boundary, is known.

The initial s values are determined, after the stable middle points are identified, by measuring a distance from a supermode boundary by biasing the front and back currents to drive the laser at the stable point and incrementing the front and back currents sufficiently to cross a supermode boundary. This is detected by a large change in wavelength and/or power emitted by the laser. Electronically this process may be implemented by subjecting the laser to a fast programmed current waveform using digital to analogue converter circuits.

The original LUT has the original or last-measured s and l values stored for comparison with the new values s′,l′ shown in FIG. 7.

If after a period these values have changed significantly preventative action can be taken, for example, the laser may be re-characterised or replaced. A threshold change indicating that the laser has aged or otherwise deteriorated may be determined from a change in value exceeding a predetermined permitted change or a percentage change exceeding a predetermined permitted percentage change.

The monitoring method is a diminutive version of the full look-up table version of the invention. Referring to FIG. 8, in which each of the frequency bars 81 indicates a frequency range emitted by the laser for a respective supermode number, after finding stable operating points for a laser chip away from mode boundaries, the laser chip is tested to ensure that all frequencies in a range of interest may be generated, as in the case shown in FIG. 8. That is, taken together, all the frequency bars 81 cover the required frequency range, without any substantial frequency gaps. If all the frequencies cannot be generated, the chip fails the quality control monitoring test and is rejected, without proceeding to the generation of a look-up table for the laser. However, for chips which pass the quality control test, the look-up table is generated after the laser is packaged. Thus the use of a screen display of the frequency coverage of a laser on a chip, corresponding to FIG. 8, provides an extremely fast quality test for laser chips.

It is found that monitoring the stability factors takes about 1 minute per laser, and this speed is ideally suited to a telecommunications application since with line terminal equipment per telecommunications optical fibre comprising 160+40 lasers, a full check may be carried out in only 200 minutes compared with 36 or more hours downtime required with alternative known schemes.

Alternatively, a single stable point may be located within a few milliseconds. It is anticipated that this may be achieved even faster with improved microcircuits.

The method comprises the use of a filter as described in WO01/28052, along with current input and power and wavelength output data acquisition circuits, DAQs. While the LUT is being generated the stability factors are also gathered and stored. These can be periodically checked using the stable middle lines 143, FIG. 3, for the laser by applying programmed electronic waveforms.

1-14. (Cancelled)

15. A method of characterising a tuneable multi-section semiconductor laser comprising the steps of a) applying currents in step-wise increments to sections of the laser respectively; b) measuring power output by the laser to determine values of the applied currents corresponding to respective stable operating conditions for which the laser emits radiation at wavelengths remote from mode boundaries of the laser; c) determining the respective wavelength of the emitted radiation; d) measuring variations in the applied currents required to cross a mode boundary such that the laser emits at a wavelength different from that under the respective stable operating condition; and e) storing in a look-up table respective values of applied currents for which the laser emits radiation at wavelengths remote from mode boundaries, the corresponding wavelengths of the radiation and the variations in applied currents required to cross adjacent mode boundaries.

16. A method as claimed in claim 15, wherein step a) comprises applying currents in step-wise increments using a programmed waveform.

17. A method as claimed in claim 15, wherein the programmed waveform has a frequency of 100 kHz.

18. A method as claimed in claim 15, wherein the programmed waveform has a frequency of 1 MHz.

19. A method as claimed in claim 15, wherein step d) of measuring the variations comprises deriving the variations by determining distances in an applied current plane of a point corresponding to the stable operating condition from adjacent longitudinal and super-mode boundaries.

20. A method as claimed in claim 15, wherein the stored variations are normalised.

21. A method as claimed in claim 15, wherein the multi-section semiconductor laser has front, gain, phase and back sections and step a) includes the steps of a1) applying constant currents to the gain and phase sections such that the laser emits laser radiation; a2) applying back and front currents in step-wise increments to the back and front sections respectively; and step e) includes storing in a look-up table the values of front and back current for which the laser emits radiation at wavelengths remote from mode boundaries.

22. A method as claimed in claim 21, wherein step c) includes step c1) providing an optical filter for transmitting a proportion of power of an incident light beam emitted by the laser, the proportion being dependant on the wavelength of the incident light beam; and step c2) measuring the proportion of power transmitted by the filter to determine the wavelength of the emitted radiation.

23. A method as claimed in claim 21, wherein step a) comprises holding the front current at a first front constant and varying the back current, holding the front current at a second front constant and varying the back current, holding the back current at a first back constant and varying the front current, holding the back current at a second back constant and varying the front current, and increasing the front current from a third front constant to a fourth front constant while decreasing the back current from a third back constant to a fourth back constant, thereby defining a first diagonal line of measurement, in order to determine stable middle lines within each super-mode and wherein, having determined the stable middle lines, subsequent steps of varying the back current and/or the front current respectively comprise varying the respective current through a window of a plurality of incremental values along the stable middle lines and determining for which of the plurality of incremental values the power output is a minimum, and repeatedly incrementing each of the plurality of incremental values and re-determining the current value corresponding to the minimum output power within the window to determine a current value corresponding to a local minimum in the power output.

24. A method as claimed in claim 23, including the further step of increasing the front current and decreasing the back current to determine further stable points along further diagonal lines of measurement parallel to the first diagonal line of measurement to generate a mode map for display on a visual display.

25. A method as claimed in claim 21, wherein step b) comprises determining midpoints between the current values corresponding to local minima in the power output to obtain stable middle points of operation of the laser and step e) includes storing data representative of such stable middle points together with the corresponding wavelength of emitted laser light in the look-up table and wherein operational conditions for operating the frequencies between the stable middle point frequencies are determined by determining and storing in the look-up table the required values of phase current injected into the phase section of the laser and wherein the required values of phase current are determined by holding the back and front currents constant successively at a first stable point and incrementing the phase current until a frequency of laser emission corresponding to a next stable point is reached and calculating what increments of phase current are required to step from frequency of the first stable point to the frequency of the second stable point in desired frequency increments.

26. A method as claimed in claim 15 comprising the further step of f) measuring the variations in the applied currents at predetermined intervals of time to determine new values of the variations; and g) comparing the new values with previously determined values of the variations to determine whether any change in the values is sufficient to require re-characterisation of the laser.

27. A method as claimed in claim 26, wherein step g) comprises comparing the new values with values stored in the look-up table when the laser was last characterised.

28. A method as claimed in claim 26 wherein the step of determining whether any change in the values is sufficient to require re-characterisation of the laser comprises determining whether the variations are greater than a predetermined value or represent more than a predetermined percentage change.
